(19) United States
(12) Patent Application Publication
(10) Pub. No.: US 2011/0081540 A1
(43) Pub. Date: Apr. 7, 2011

(54) WEAR-RESISTANT COMPONENT

(76) Inventors: Marcus Kennedy, Dusseldorf (DE); Michael Zinnabold, Burscheid (DE); Marc-Manuel Matz, Friedberg (DE)

(21) Appl. No.: 12/922,561

(22) PCT Filed: Jan. 20, 2009
(86) PCT No.: PCT/EP2009/000324

§ 371 Date: Dec. 7, 2010

(30) Foreign Application Priority Data
Mar. 14, 2008 (DE) 10 2008 014 333.2

(51) Int. Cl. B32B 5/00; B32B 15/04; C23C 4/08; C22C 38/36; C22C 38/32; C22C 30/00

(52) U.S. Cl. 428/336; 428/457; 427/456; 420/11; 420/64; 420/583

(57) ABSTRACT

The present invention pertains to wear-resistant components for internal combustion engines, particularly piston rings, that feature a wear protection layer with iron base alloy on their surface that is subjected to wear and are characterized in that the components are manufactured of a coating powder by means of high-velocity flame spraying (HVOF) and the coating is single-phase, wherein the proportions of the elements Fe, Cr, B and C in the wear protection layer are 45-75 wt.-% Fe, 15-40 wt.-% Cr, 1-10 wt.-% B and 0.1-5 wt.-% C. The present invention furthermore pertains to a method for manufacturing wear-resistant components for internal combustion engines, particularly piston rings, according to the present invention.

The present invention pertains to wear-resistant components for internal combustion engines, particularly piston rings. The present invention furthermore pertains to a method for manufacturing the inventive wear-resistant components by means of a thermal spraying method.

In piston rings such as, for example, those of reciprocating internal combustion engines, a high resistance to wear needs to be ensured because the layer otherwise becomes thinner, i.e., at a low resistance to wear. This results in a reduced wall thickness of the piston ring, in an inferior sealing effect and in increased gas leakage and oil consumption, wherein the engine performance may also deteriorate. An abrading piston ring causes the gap between the cylinder wall and the piston ring to gradually increase such that the combustion gases can more easily escape past the piston ring (so-called blow-by) and the efficiency of the engine is reduced. An enlarged gap also causes the oil film that is not stripped off and remains in the combustion chamber to become thicker such that more oil can be lost per time unit, i.e., the oil consumption may increase.

In the thermal spraying of piston rings, it is nowadays preferred to utilize molybdenum-based materials that are processed by means of plasma spraying. However, these materials have an excessively high rate of wear in highly stressed engines.

The high-velocity flame spraying technology (HVOF) provides the option of depositing particles on a substrate with a low thermal effect and high kinetic energy in such a way that dense layers with a high adhesion are produced. In order to also ensure an improved resistance to wear under higher stresses, metal carbide particles such as, for example, WC or Cr₃C₂ have been recently utilized. Although these particles actually have a higher resistance to wear, they also have certain disadvantages due to their physical properties that differ from those of the substrate, e.g., lower thermal coefficient of expansion and lower thermal conductivity, and due to their different mechanical properties, e.g., lower ductility, higher brittleness and lower fracture toughness. These disadvantages manifest themselves during the operation of the engine, particularly in mixed friction or insufficient lubrication. The thermal energy additionally induced due to friction leads to a relaxation process, in which the piston ring layer cannot follow the expansion of the substrate such that a network of cracks is created on the running surface. This effect ultimately leads to failure under repeated stress. The metal carbides are usually also introduced into a metallic matrix such as, for example, a NiCr alloy, wherein only wetting of the alloy surface occurs, but no metallurgic linking. This limits the adhesion of metal carbides, such as WC or Cr₃C₂, that provide a high resistance to wear in the form of hard material regions.

It is therefore the objective of the present invention to improve the tribological properties of components for internal combustion engines, particularly of piston rings, in comparison with those of components with a molybdenum coating or a conventional metal carbide coating.

This objective is attained, according to the invention, with wear-resistant components for internal combustion engines, particularly piston rings, that feature a wear protection layer with iron base alloy on their surface that is subjected to wear and are characterized in that the components are manufactured of a coating powder by means of high-velocity flame spraying (HVOF) and the coating is single-phase, wherein the proportions of the elements Fe, Cr, B and C in the wear protection layer are 45-75 wt.-% Fe, 15-40 wt.-% Cr, 1-10 wt.-% B and 0.1-5 wt.-% C. In this case, a FeCr base alloy is strengthened due to the formation of FeB precipitates with embedded C-atoms. A homogenous system between substrate and coating is produced, in particular, with respect to the physical properties such as thermal conductivity and thermal coefficient of expansion. Consequently, the thermal energy created during mixed friction in the TDC (top dead center) or BDC (bottom dead center) can be dissipated more easily and a uniform thermal relaxation process during the temperature fluctuations occurring in the internal combustion engine can be ensured. Since the wear protection layer only consists of a single phase, the wetting characteristics that are very difficult to test quantitatively do not have to be taken into account.

The thickness of the wear protection layer preferably lies between 30 μm and 600 μm.

The wear protection layer is preferably manufactured of a coating powder with an average particle size of less than 65 μm measured by means of a Cilas granulometer.

The present invention furthermore pertains to a method for manufacturing inventive wear-resistant components for internal combustion engines, particularly piston rings. In this case, a wear protection layer is applied onto the component by means of high-velocity flame spraying (HVOF, e.g., MKJet® by the firm Federal-Mogul).

The present invention is elucidated in greater detail below with reference to one example that should not be interpreted in a restrictive sense.

### EXAMPLE

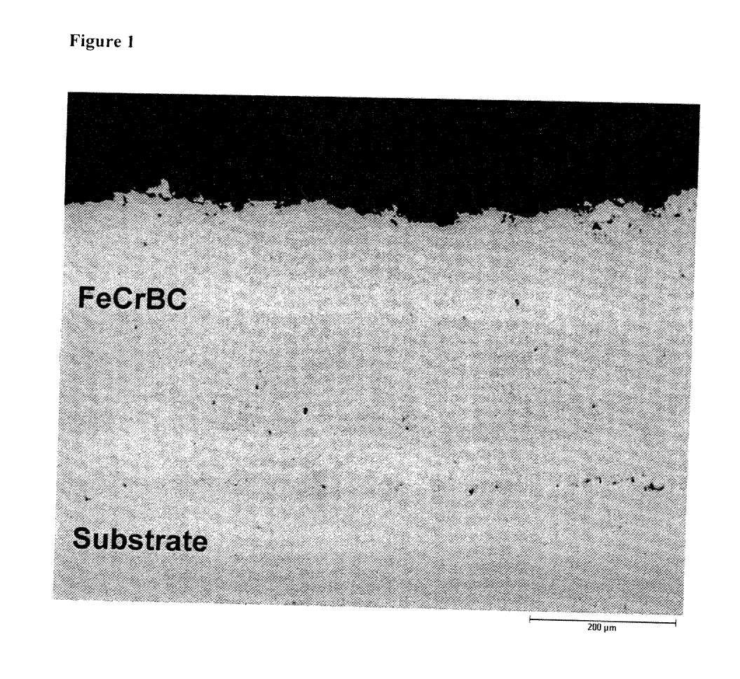

A wear protection layer was applied onto a piston ring by means of high-velocity flame spraying. A coating powder of FeCrCB with an average particle size of 20-63 μm was used for this purpose. The microstructure of an exemplary wear protection layer that was inspected by means of light-optical microscopy is illustrated in FIG. 1. The test was carried out four times with different process parameters and the hardness, the roughness and the ductility were measured by determining the crack length by means of an HV10 indenter test. The results are presented in Table 1. The hardness was determined in accordance with DIN EN ISO 4516, the layer thickness was determined in accordance with DIN EN ISO 9220 and 1463, the roughness characteristics were determined in accordance with DIN EN ISO 4287 and 4288, and the ductility was determined in accordance with DIN EN ISO 14577. Particularly the improved ductility in comparison with MKJet502 (DE 100 61 750 B4) (MKJet502: 200-350 μm) at the same porosity and adhesion suggest that this material has superior thermophysical and therefore tribological properties during the operation of the engine.

TABLE 1
Evaluation criteria for an HVOF-sprayed FeCrBC layer

| | | | Layer | | | Crack | σ (Crack |
|---|---|---|---|---|---|---|---|
| Test | | | thickness | Ra | Rz | length | length) |
| # | HV0.3 | σ (HV0.3) | [μm] | [μm] | [μm] | [μm] | [μm] |
| 1 | 1149 | 88 | 390 | 7.6 | 49.2 | 229 | 56 |
| 2 | 1121 | 103 | 390 | 7.9 | 48.8 | 166 | 86 |
| 3 | 1134 | 117 | 410 | 7.3 | 44.8 | 114 | 59 |
| 4 | 1224 | 128 | 420 | 7.3 | 47.7 | 129 | 62 |

1-4. (canceled)

5. Wear-resistant component for internal combustion engines having a wear protection layer with iron base alloy on the surface of the component that is subjected to wear and wherein the components is manufactured of a coating powder by means of thermal spraying and the coating is single-phase and wherein the proportions of ht elements Fe, Cr, B and C in the wear protection layer are
Fe: 45-75 wt.-%,
Cr: 15-40 wt.-%,
B: 1-10 wt.-%,
C: 0.1-5 wt.-%.

6. The wear-resistant component of claim 5, wherein the wear protection layer has a thickness of between 30 μm and 600 μm.

7. The wear-resistant component of claim 5, wherein the wear protection layer is manufactured of a coating powder with an average particle size of less than 65 μm.

8. A method for manufacturing a wear-resistant component for internal combustion engines according to claim 5, wherein the wear protection layer is applied onto the component by means of a high-velocity thermal spraying (HVOF).

9. The wear-resistant component of claim 5, wherein the component is a piston ring.

10. The method of claim 8, wherein the component is a piston ring.
